(19) United States
(12) Patent Application Publication
(10) Pub. No.: US 2006/0283040 A1
(43) Pub. Date: Dec. 21, 2006

(54) De-misting system for multi-pane glazing

(76) Inventor: David Ferracuti, Mississauga (CA)

Correspondence Address: D.W. EGGINS, 18 DOWNSVIEW DRIVE, BARRIE, ON, L4M 4P8, CA

(21) Appl. No.: 11/475,194

(22) Filed: Jun. 27, 2006

Related U.S. Application Data
(63) Continuation-in-part of application No. 11/146,056, filed on Jun. 7, 2005.

(51) Int. Cl. F26B 3/00

(52) U.S. Cl. 34/329

(57) ABSTRACT

Multi-pane glazing units have their internal cavity vented to atmosphere by way of one or more venting apertures that are plugged by porous ‘breathing’ plugs of predetermined permeativity, to permit controlled equalization of cavity pressure with the atmosphere. The provision of two such apertures permits the admission of a flow of demoisturizing air or other gas, to de-mist the glazing unit. The plugs permit the outward transfer of moisture from the unit cavity, and may control the rate of cavity pressure change. The outer glazing pane may be thicker than the inner pane, to better withstand wind gusts. The venting apertures may be through the glass or the unit peripheral seal.

### CROSS REFERENCE TO RELATED APPLICATIONS

This Application is a Continuation-in-Part of application Ser. No. 11/146,056 filed Jun. 7, 2005, which is embodied herein by reference.

### STATEMENT REGARDING FEDERALLY SPONSORED RESEARCH OR DEVELOPMENT

(N/A)

### REFERENCE TO MICROFICHE APPENDIX

(N/A)

### BACKGROUND OF THE INVENTION

This invention is directed to a system for removing moisture and water vapour from the interior cavity or cavities of multi-pane glazing units, and includes provisions to maintain such de-misted cavities in an ongoing, substantially de-misted condition, including application of the system to new window units.

2. Multi-pane glazing units usually consist of an inner and an outer pane, generally of glass, having a hermetic seal about the periphery, and frequently containing rare gases such as argon, to minimize thermal transfer through the unit. Owing to imperfections of such peripheral seals, and for other possible causes, moisture penetrates into the interior cavity of the glazing unit, to form a mist over its inner surfaces, and mar its appearance. Also, such moisture contamination has been found to reduce the insulative R value of the unit by as much as 80%. One prior system that attempts to deal with the problem involves accessing the interior cavity, spraying a de-moisturizing agent within the cavity, and sealing the access aperture by way of a simple flap valve that is intended to permit ready egress of gases from the unit cavity, while preventing the ingress of outside air to the cavity. This prior system is ineffective, both in its initial de-misting, and in the effectiveness of the flap valve provision.

### BRIEF SUMMARY OF THE INVENTION

In accordance with the present invention there is provided a system, applicable to pre-existing and new glazing units, having an apparatus for pumping dry air at a controlled flow rate into and through a selected window cavity, to dry-out and purge that cavity of any moisture present, and to fill it with de-moisturized air, followed by the application of sealing means to control access to the cavity and to substantially re-seal the window cavity.

In a preferred embodiment, the air is pre-dried, and may be heated to optimize the rate of moisture removal; and the sealing means consists of a plug of controlled permeability, permitting the up-take and outward transfer of moisture from the cavity, while resisting any reversed moisture transfer into the cavity. This plug may include a water-attracting hydrophilic portion that is positioned within the window cavity, and a hydrophobic end portion that encloses the cavity aperture, to resist the ingress of moisture to the cavity.

The hydrophilic portion of the plug may be blended with particles of dessicant material, such as silica jel, to enhance water up-take. Thus, the plug valves may be comprised of porous polymers that may or may not contain dessicants.

The ‘plug valves’ can consist of plastic porous resins (e.g. Polymers). The alternatives of ceramics, and fibers that transfer moisture through capillary action and forces of adhesion, cohesion, and surface tension are contemplated. Material selection is based upon providing an effective performance, where porosity, costs, aesthetics and enviromental consideration come into play. Both metal and plastic materials may be sintered to provide predetermined degrees of porosity, in order to control the rate of pressure change within the window cavity in response to wind gusts operating against the outer window face; and to achieve acceptable levels of air flow/moisture transfer by way of wicking, capillary action, venting/aeration and moisture evaporation from the cavity.

The control valves can be comprised of a range of plastic and other materials, including: polycarbonate (PC) material; polypropylene, (PP); polyethylene, (PE); ceramics, powdered metals, many of the well known polyolefins and materials that can be polymerized.

These material are sintered; making the material porous in nature, thus allowing
a) equilization of pressure, and
b) passage of air/moisture via wicking, capillary action, venting/aeration and evaporation from the cavity of the glass unit.

In comparing the structural strength of existing non-vented windows with new windows vented in accordance with the present invention, the outer sheet of the vented new window may be made of greater thickness, for improved gust resistance. Also, the subject plug valves may have predetermined low air transfer rates, to promote wind-gust load transfer from the outer window sheet to the inner window sheet.

In purging the window cavity, the air displacement apparatus receives air from a compressor, passes the compressed air through a dryer, to reduce the amount of moisture that may be present, filters the air, and reduces the pressure to a predetermined lower range of pressures.

The air may be heated to a predetermined temperature, in accordance with the ambient conditions, and the characteristics of the window. Safe operating temperatures lie in the range of 20 to 40 degrees Celsius, and temperature and air flow rate selection are predicated upon window size and the thickness of the glass.

Larger window size and the use of thinner glass both adversely affect the permissible value of selected air temperature and the rate of air admission.

The dried, filtered, pressure-controlled air, preferably in a heated condition for enhanced drying rates, passes to an air gun equipped with a nozzle hose, for passage as a purging medium within the cavity of a multi-pane glazing unit.

In the case of existing, non-vented windows that require venting, ventilation access holes are drilled at the bottom and the top of the subject glazing unit, preferably in mutual diagonal relation, so that the purging medium can flow diagonally upwardly through the unit cavity, vapourizing and entraining moisture that is present, and removing it from the cavity.

On completion of a purging operation the ventilation access holes are each plugged with a sealing plug, as described above.

The access holes may be drilled from the interior of the window, or from the exterior, and may traverse the window, or be limited to penetration of the window cavity.

In applying the earlier teachings of the subject parent case to the venting of new-construction windows, a single venting cavity may be provided in an upper corner, usually in the window outer sheet.

The venting cavity is preferably plugged with a plug of predetermined low permeability, so that under high wind gust conditions there is a gradual change in the internal pressure within the window unit, so as to preserve the strength characteristics of the unit.

Thus, in addition to serving as a vapour vent, this plugged cavity can also provides the function of controlled pressure equalization, such that changes in atmospheric pressure are adjusted to, with associated stress reduction in the glass sheets, and more particularly, in the peripheral boundary seals.

The strength of window units may be enhanced by the adoption of a thicker outer window sheet, to promote the gust resistance integrity of the unit.

The present invention thus provides a multi-pane glazing unit having at least two glazing panels in mutually spaced substantially parallel relation; a peripheral seal in substantial sealing relation about the periphery of the panels; to form an enclosed cavity therewith; at least one access aperture connecting the cavity to atmosphere; and plug means removably inserted in the access aperture, to provide access to said the cavity.

The access aperture may extend through a glazing panel, or through the peripheral seal.

The glazing unit may have two such access apertures positioned in substantially diagonally opposed relation in the unit, or in mutually spaced relation adjacent the top and the bottom of the unit.

One glazing panel may be of greater thickness than the other glazing panel, to resist wind gusts.

The plug means is preferably of predetermined permeability to provide atmospheric access to the cavity.

The plug means is preferably of sintered material selected from the group consisting of polycarbonate; polypropylene, polyethylene, ceramics, powdered metals, and polymerizable polymer, being preferably of predetermined permeability.

The sintered plug material is of predetermined particle size to provide its predetermined permeability.

The permeable plug means may include a cylindrical hydrophilic inner portion for insertion within the cavity of the unit, and a hydrophobic outer portion to substantially seal the cavity against ready moisture transfer inwardly therethrough.

The plug means may be of high porosity plastic, to enable the transfer of water therethrough.

The hydrophobic plug portion may include a dessicant material in blended relation with a high porosity plastic.

The invention thus provides a method of controlling pressure and humidity conditions within the cavity of a multi-pane glazing unit, comprising the steps: forming at least one atmospheric access aperture to the glazing pane cavity, to connect the cavity with atmosphere, and plugging the access aperture with a plug of predetermined permeativity, made of material selected from the group consisting of polycarbonate, polypropylene, polyethylene, ceramics, powdered metals, and polymerized polyolefin material, to facilitate the egress of water vapour from the cavity, and to substantially maintain atmospheric pressure within the cavity.

Two such access apertures to the cavity may be formed, in mutually spaced relation to facilitate the passage of a moisture-entraining gas through the cavity.

The compressed gas may be dried prior to passing it into the cavity; also, it may be heated and compressed prior to passing the gas into the cavity, to enhance the uptake of moisture by the gas within the cavity.

The glazing unit may have one of its panes of greater thickness than the other glazing pane, to better withstand wind forces acting on the glazing unit.

### BRIEF DESCRIPTION OF THE SEVERAL VIEWS OF THE DRAWINGS

Certain embodiments of the invention are described by way of illustration, without limitation thereto other than as set forth in the accompanying claims, reference being made to the accompanying drawings, wherein:

FIG. 1 is a schematic general view of a glazing unit having ventilation access holes;

FIG. 2 is a side elevation of an embodiment of a vapour-purging apparatus in accordance with the present invention;

FIGS. 3 and 4 are sectioned side views of two embodiments of window cavity sealing plugs in accordance with the present invention;

FIG. 5 is a general view from the outside of a new window unit incorporating the present invention, applied through the glazing unit;

FIG. 5A is a scrap view, with application through the peripheral seal;

FIG. 6 is a view similar to FIG. 5 of a further embodiment of a new window unit; and,

FIG. 6A is a scrap view showing a second plug applied through the peripheral seal.

### DETAILED DESCRIPTION OF THE INVENTION

It will be understood by those skilled in the art that the above disclosure is directed primarily to specific embodiments of the present invention, and that the subject invention is susceptible of reduction to practice in other embodiments that fall within the scope of the appended claims.

Referring to FIG. 1, a glazing unit 10 comprising a thermopane (T.M.) window has an inner glazing sheet 12 and an outer glazing sheet 14, the periphery of which sheets are sealed in spaced relation by an initially hermetic peripheral seal 15.

The unit 10, as is well known, is installed with supporting hardware (not shown), as part of a wall of a building.

For purposes of the present invention the unit 10 is presumed to have suffered failure of the hermetic seal 15, with consequent inward leakage of moisture into the unit inner cavity 16, which results in misting of one or both of the inner glazing surfaces of unit 10.

Access to the cavity 16, as a preliminary step of the present process is attained by the drilling of access bores 18, 20, respectively located at the bottom and top of the window unit 10. Typically, the bores 18, 20 are in the order of three to four millimeters diameter (i.e. about 0.12 to 0.16 inches diameter).

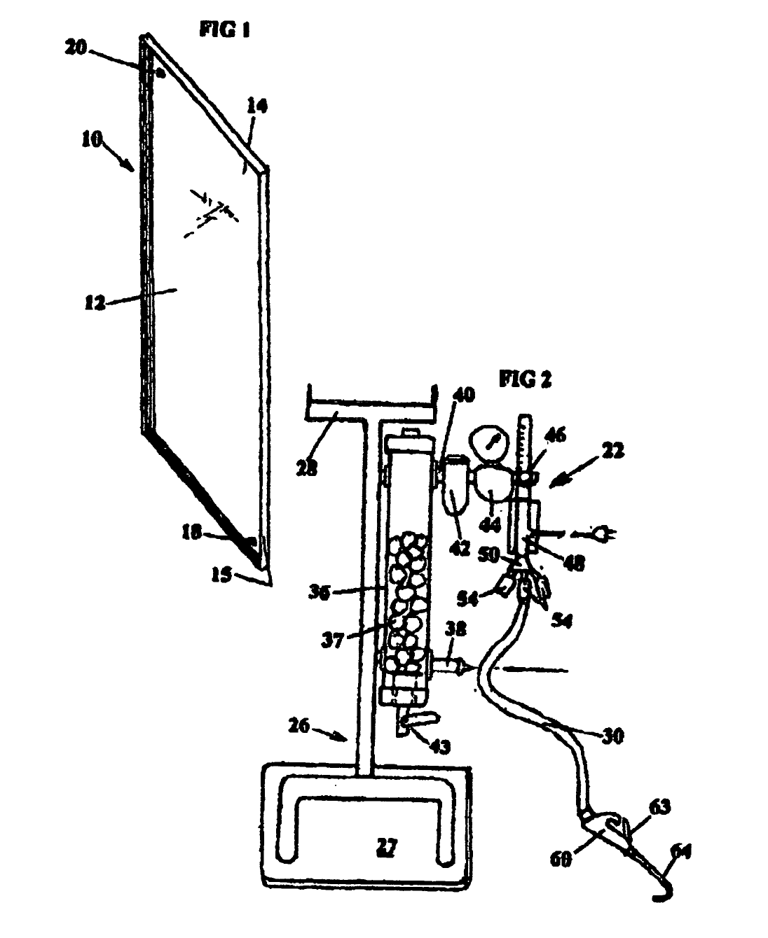

Turning to FIG. 2, the air displacement apparatus 22 has a tubular support stand 26 supported on a base member 27. The support stand 26 has a transversely extending hose rack 28 on which service hoses 30 are stored and transported.

A cylindrical air dryer 36 is mounted vertically on the stand 26, having an air inlet 38 and air outlet 40. The dryer 36 is charged with silica gel dessicant 37, through which air travels upwardly. A lower drain valve 43 permits downward drainage of accumulated water from the dryer 36. The air outlet 40 connects to an air filter 42, the outlet of which connects with a pressure regulating valve 44, a flow valve 46 and an air heater 48, all connected in series relation. The heater 48 has a heat shield thereabout.

The outlet of the heater 48 connects with a manifold 50, having a number of quick-disconnect couplers 54, to which small diameter air hoses 30 (of which only one is illustrated) are connected. Each air hose 30 serves a respective air gun 60, having a control lever 63. The gun 60 is fitted with a small diameter outlet hose 64 that is sized to fit the access bore 18 in the glazing sheet 12.

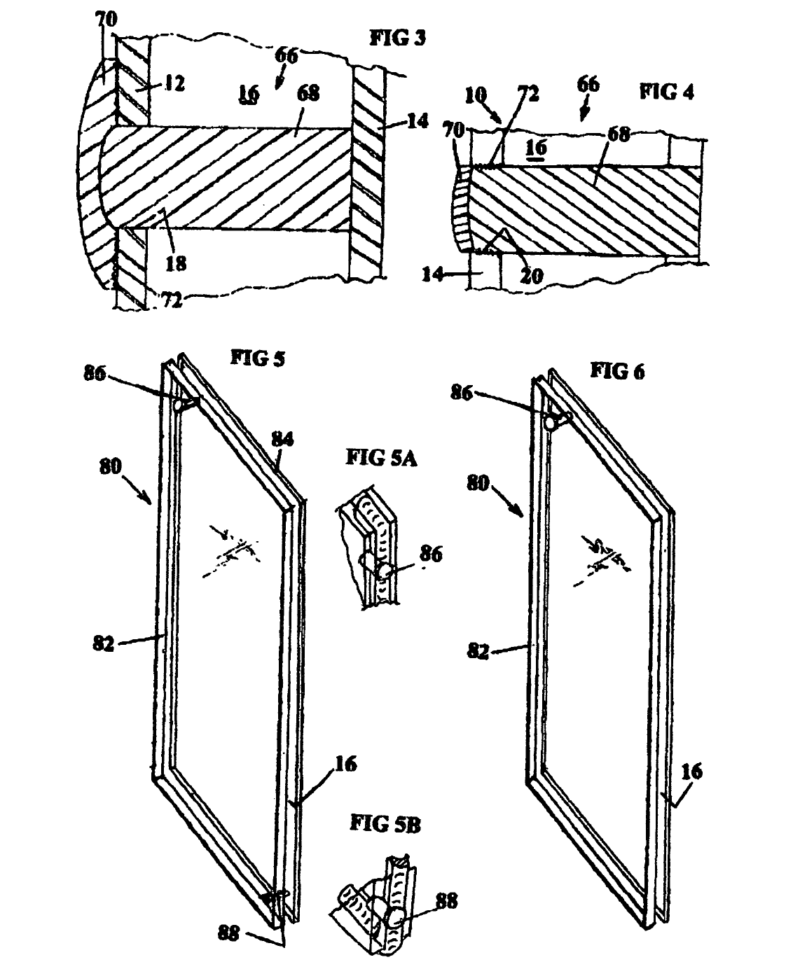

Turning to FIGS. 3 and 4, the window unit of FIG. 3 is drilled from the inside, having only the inner sheet 12 drilled; while the unit 10 of FIG. 4 is drilled from the outside, having the outer sheet 14 and the inner sheet 12 both drilled.

The sealing plugs 66 have a cylindrical body portion 68 consisting of a high porosity plastic compound of hydrophilic polyurethane, possibly blended with a dessicant, and an outer end portion 70 of high porosity hydrophobic polyurethane.

Other plug embodiments may be selected from the above-recited group of materials.

The outer end portion 70 may have an adhesive surface coating 72 at its interface with the glazing sheet 12.

The sealing plugs 66 are sized diametrically to provide a tight push fit with the access bores 18, 20.

In use, to treat a defective glazing unit 10 that has evidenced water vapour fogging of its inner surface or surfaces or droplet formation, access bores 18, 20 are drilled near the bottom and top corners of the glazing unit, through the edge seal or through the edges of the accessible glazing sheet such as inner glazing sheet 12 of unit 10. The glazing sheets may be of glass or plastic.

An air displacement apparatus 22 is coupled at air inlet 38 by hose to a compressed air supply (not shown), operating at standard supply pressure in the range 100 to 125 psi. The admitted air flows through the air dryer 36, passes through the air filter 42 to the pressure regulator 44 and flow valve 46, where the pressure is dropped to a value of 5-10 psi (gauge).

In the heater 48 the temperature of the air may be raised a desired amount, to promote drying rates. This temperature selection may be influenced by the length of the air hoses 58 and the ambient temperature to which the window outer glazing sheet 14 is subject, so as to avoid thermal shock to the unit 10, with consequent damage.

The several outlet couplers 54 of the manifold 50 permits the apparatus to service a corresponding number of adjacent windows simultaneously.

In the case of new installations, such as illustrated in FIGS. 5, 5A, FIG. 6 and 6A, the outer glazing sheet 82 of a glazing unit 80 is illustrated as having greater thickness than the inner glazing sheet 84, for the reasons given above.

It will be appreciated that the drawings are purely illustrative, showing only the glazing units with their plugged apertures, and are not to scale.

In FIG. 5, the provision of upper and lower plugged apertures 86 and 88 enables the unit to be purged with dry air or other gases, at the time of installation. FIGS. 5A and 5B show manners of use, through the peripheral seal of the unit.

The apertures 86 and 88 are illustrated as being diagonally positioned in FIG. 5, for optimum scouring effect by the purge gas. FIG. 5A shows the location of aperture 86 in the upper portion of the peripheral seal of the unit. FIG. 5B shows an aperture 88 located in a lower corner of the peripheral seal of the unit.

In FIG. 6, there is shown a single plugged aperture 86, such that the cavity 16 is maintained substantially at atmospheric pressure, while the humidity level is maintained at a low level by the action of the plugged aperture 86. By selection of a low permeability formulation for the plug, the rate of change of pressure in cavity 16 may be such as to act in the manner of a shock absorber, when wind gusts are encountered.

The location of the plug or plugs in the top run of the peripheral seal may communicate with, and ventilate to the crown space located above the glazing unit.

1. A multi-pane glazing unit having at least two glazing panels in mutually spaced substantially parallel relation; a peripheral seal in substantial sealing relation about the periphery of said panels; to form an enclosed cavity therewith; at least one access aperture connecting said cavity to atmosphere; and plug means removably inserted in said access aperture, to provide access to said cavity.

2. The glazing unit as set forth in claim 1 wherein a said access aperture extends through a said glazing panel.

3. The glazing unit as set forth in claim 1, wherein a said access aperture extends through said peripheral seal.

4. The glazing unit as set forth in claim 1, having two said access apertures positioned in substantially diagonally opposed relation in said unit.

5. The glazing unit as set forth in claim 2, having two said access apertures positioned in substantially diagonally opposed relation in said unit.

6. The glazing unit as set forth in claim 3, having two said access apertures positioned in substantially diagonally opposed relation in said unit.

7. The glazing unit as set forth in claim 1 having two said access apertures positioned in mutually spaced relation adjacent the top and the bottom of said unit.

8. The glazing unit as set forth in claim 1, wherein one said glazing panel is of greater thickness than the other said glazing panel.

9. The glazing unit as set forth in claim 1, wherein said said plug means is of predetermined permeability to provide atmospheric access to said cavity.

10. The glazing unit as set forth in claim 9, wherein said plug means is of sintered material selected from the group consisting of polycarbonate; polypropylene, polyethylene, ceramics, powdered metals, and polymerizable polymer, and is of predetermined permeability.

11. The glazing unit as set forth in claim 10, wherein said plug means sintered material is of predetermined particle size to provide said predetermined permeability.

12. The glazing unit as set forth in claim 9, wherein said permeable plug means includes a cylindrical hydrophilic inner portion for insertion within said cavity, and a hydrophobic outer portion to substantially seal said cavity against ready moisture transfer therethrough.

13. The glazing unit as set forth in claim 10, wherein said plug means is of high porosity plastic, to enable the transfer of water therethrough.

14. The glazing unit as set forth in claim 10, wherein said hydrophobic portion includes a dessicant material in blended relation with a high porosity plastic.

15. The apparatus as set forth in claim 8, wherein said access aperture is located in a dual pane glazing unit and extends through at least one pane of said unit.

16. The method of controlling pressure and humidity conditions within the cavity of a multi-pane glazing unit, comprising the steps: forming at least one atmospheric access aperture to said glazing pane cavity, to connect said cavity with atmosphere, and plugging said access aperture with a plug of predetermined permeativity, made of material selected from the group consisting of Polycarbonate, polypropylene, polyethylene, ceramics, powdered metals, and polymerized polyolefin material, to facilitate the egress of water vapour from said cavity, and to substantially maintain atmospheric pressure within said cavity.

17. The method as set forth in claim 16, wherein at least two said access apertures to said cavity are formed, being in mutually spaced relation to facilitate the passage of a moisture-entraining gas through the cavity.

18. The method as set forth in claim 17, including drying said compressed gas prior to passing said gas into said cavity.

19. The method as set forth in claim 16, including the step of heating said compressed gas prior to passing the gas into said cavity, to enhance the uptake of moisture by the gas within the cavity.

20. The method as set forth in claim 16, wherein said glazing unit has an inner and an outer glazing pane, and one said pane is of greater thickness than the other said glazing pane, to better withstand wind forces acting on said glazing unit.
